(19) United States
(12) Patent Application Publication
(10) Pub. No.: US 2025/0173506 A1
(43) Pub. Date: May 29, 2025

(54) COMPUTERIZED-METHOD FOR COMPREHENSIVE TEXT SUMMARIZATION QUALITY ASSESSMENT WITH RANK-BASED NORMALIZATION AND WEIGHTED HIERARCHICAL RANKING

(71) Applicant: ACTIMIZE LTD., Ra'anana (IL)

(72) Inventor: Danny BUTVINIK, Haifa (IL)

(21) Appl. No.: 18/520,586

(22) Filed: Nov. 28, 2023

(51) Int. Cl. G06F 40/284; G06F 40/295

(52) U.S. Cl. CPC G06F 40/284; G06F 40/295

(57) ABSTRACT

A computerized-method for comprehensive text-summarization quality-assessment with rank-based normalization and weighted-hierarchical-ranking strategy. The computerized-method includes: (i) receiving an original-text and a summary-text that has been generated by a (GPT)-based LLM that has been provided the original-text and a text-prompt; (ii) operating a text-processing NLP module on the original-text and the summary-text to yield a processed-text of both; (iii) measuring the summary-text to assess text-summarization-quality thereof by operating a plurality of metrics to yield a metric-score; (iv) operating ranked-based normalization on each metric-score to yield a normalized-score; and (v) operating an aggregation based on weighted-hierarchical-ranking strategy of the normalized scores to yield an interpreted final-quality score. The interpreted final-quality score indicates a comprehensive text summarization quality assessment of the summary-text, and the plurality of metrics includes: (i) grammatically; (ii) Flesch-Kincaid (FK) readability; (iii) topic coverage; (iv) compression ratio; (v) cosine similarity; (vi) NER accuracy; (vii) BLEU; and (viii) ROUGE.

### TECHNICAL FIELD

The present disclosure relates to the field of Artificial Intelligence (AI), and more specifically, to the field of comprehensive text summarization quality assessment with rank-based normalization and weighted hierarchical ranking using AI models.

### BACKGROUND

Text summarization has become significantly necessary due to a constantly increasing volume of online textual data and the need for efficient information retrieval and management. There are various methods and systems to assess quality of text summarization outputs of a Generative Pre-trained Transformer (GPT)-based Large Language Model (LLM). The quality assessment is operated to improve the accuracy and relevance of the generated summaries.

A Large Language Model (LLM) is a type of machine learning model that can perform a variety of Natural Language Processing (NLP) tasks, such as generating and classifying text based on prediction, e.g., based on what is already known, what will happen in a new situation. LLM use a type of deep neural network to generate the output that it has learnt during training. LLMs are trained on vast amounts of text data, enabling them to understand, generate, and interact with human language at an unprecedented scale and depth. LLMs are pivotal in producing high-quality, coherent, and contextually relevant summaries in text summarization quality assessment.

Traditionally, text summarization quality assessment has relied on manual evaluation metrics, such as Recall-Oriented Understudy for Gisting Evaluation (ROUGE), Bilingual Evaluation Understudy (BLEU), and Metric for Evaluation of Translation with Explicit ORdering (METEOR). These metrics assess the similarity between a reference, e.g., original text and generated summaries using linguistic features, such as n-grams and word overlap. While these manual metrics have been widely used, they are labor-intensive, time-consuming, and subject to human bias.

In recent years, supervised learning approaches have been employed to assess the quality of text summaries automatically. These methods typically involve training machine learning models, such as Support Vector Machines (SVM) s or neural networks, on labeled datasets containing human-assigned quality scores for summaries. Features extracted from summaries, such as content coverage and coherence, are used to predict summary quality. However, these supervised learning approaches often require large, annotated datasets and may not generalize to different domains or languages.

Unsupervised and semi-supervised techniques have been explored to overcome the limitations of supervised learning approaches. Some prior art solutions have leveraged graph-based algorithms, clustering, and topic modeling to assess text summarization quality. While these methods can reduce the reliance on labeled data, they lack precision and robustness in certain scenarios.

Current hierarchical ranking strategies to assess the quality of text summaries at multiple levels, considering both global and local aspects, often involve aggregating quality scores from different sources or aspects of summaries, such as coherence, informativeness, and fluency. However, these existing hierarchical ranking techniques may not fully account for the varying importance of different aspects in different contexts.

While current methods aggregate scores for different summary qualities, they do so without a nuanced understanding of the context in which the summary is used. Moreover, none of current methods use advanced Natural Language Processing (NLP) techniques to more deeply understand the semantic and contextual nuances of texts, allowing for more sophisticated assessments of summary quality.

Therefore, there is a need for a technical solution for a system and method that comprehensively assesses the quality of text summarization outputs, incorporates rank-based normalization techniques, and implements a weighted hierarchical ranking strategy to provide more accurate and context-aware quality assessments.

### SUMMARY

There is thus provided, in accordance with some embodiments of the present disclosure, a computerized-method for comprehensive text summarization quality assessment with rank-based normalization and weighted hierarchical ranking strategy.

In accordance with some embodiments of the present disclosure, the computerized-method may include: (i) receiving an original text and a summary-text. The summary-text is a summary of the original text that has been generated by a Generative Pre-trained Transformer (GPT)-based Large Language Model (LLM) that has been provided the original text and a text-prompt. (ii) operating a text-processing Natural Language Processing (NLP) module on the received original text and the summary-text to yield a processed-text of the original text and a processed-text of the summary-text; (iii) measuring the summary-text to assess text summarization quality thereof by operating a plurality of metrics to yield a metric-score for each metric in the plurality of metrics. The measuring is based on the processed-text of the original text and the processed-text of the summary-text. (iv) operating ranked-based normalization on each metric-score in the plurality of metrics to yield a normalized-score for each metric in the plurality of metrics. (v) operating an aggregation based on weighted hierarchical ranking strategy of the normalized scores to yield an interpreted final-quality score. The interpreted final-quality score indicates a comprehensive text summarization quality assessment of the summary-text, and the plurality of metrics includes: (a) grammatically; (b) Flesch-Kincaid (FK) readability; (c) topic coverage; (d) compression ratio; (e) cosine similarity; (f) Named Entity Recognition (NER) accuracy; (g) Bilingual Evaluation Understudy (BLEU); and (h) Recall-Oriented Understudy for Gisting Evaluation (ROUGE).

Furthermore, in accordance with some embodiments of the present disclosure, the text-processing NLP module may include: (i) operating tokenization of the received original text and the summary-text to yield a plurality of tokens; (ii) operating lemmatization of each token in the plurality of tokens; and (iii) operating Named Entity Recognition (NER) to extract entities by classifying each token in the plurality of tokens into a category in predefined categories.

Furthermore, in accordance with some embodiments of the present disclosure, the ranked-based normalization may include: (i) sorting the plurality of metrics by the measured metric-score of each metric in the plurality of metrics to yield a sorted list of metrics; (ii) assigning a rank to each metric based on a position of the metric in the sorted list of metrics; and (iii) dividing each rank by a total number of metrics in the list of metrics.

Furthermore, in accordance with some embodiments of the present disclosure, when the interpreted final-quality score is below a preconfigured threshold, the computerized-method may further include providing feedback-details to a user via a computerized-device to modify the text-prompt and receive a regenerated summary-text of the original text from the GPT-based LLM, based on the feedback-details and then performing operations (ii) through (v).

Furthermore, in accordance with some embodiments of the present disclosure, the feedback-details may include the metric-score of each metric in the plurality of metrics.

Furthermore, in accordance with some embodiments of the present disclosure, the feedback-details may include a preconfigured number of metrics having lowest metric-score.

Furthermore, in accordance with some embodiments of the present disclosure, the feedback-details include integrated resources, and the integrated resources include at least one of: (i) style guides; (ii) grammatical rules; and (iii) topic-specific templates.

Furthermore, in accordance with some embodiments of the present disclosure, when lowest metric scores are of at least one metrics of: grammatically and topic coverage the feedback-details provides references to relevant resources from website and academic papers, and professional literature.

Furthermore, in accordance with some embodiments of the present disclosure, when the interpreted final-quality score is below the preconfigured threshold and there is an indication that a feedback-loop is not required, feedback-details are not provided to the GPT-based LLM to receive the regenerated summary-text.

Furthermore, in accordance with some embodiments of the present disclosure, when the interpreted final-quality score of a summary-text is below the preconfigured threshold, the computerized-method may further include storing the interpreted final-quality score in a database with related original text, summary-text and the plurality of metrics and corresponding metric-scores.

Furthermore, in accordance with some embodiments of the present disclosure, when the interpreted final-quality score of a summary-text is below the preconfigured threshold, the computerized-method may further include retrieving from the database previously stored one or more interpreted final-quality score, and related summary-text and the plurality of metrics and corresponding metric-scores to be presented via a display unit to a user.

Furthermore, in accordance with some embodiments of the present disclosure, the computerized-method may further include storing in a documentation-database details of the interpreted final-quality score of a summary-text that is below the preconfigured threshold, related summary-text, feedback-details and user modifications to the GPT-based LLM to regenerate the summary-text.

Furthermore, in accordance with some embodiments of the present disclosure, the aggregation based on weighted hierarchical ranking strategy of the normalized scores may include (i) calculating a sum of the normalized-score of each metric in the plurality of metrics; (ii) for each normalized-score of the plurality of metrics assigning an adjusted-weight; and (iii) calculating the interpreted final-quality score by summing weighted normalized scores. A weight of each normalized-score is the assigned adjusted-weight.

Furthermore, in accordance with some embodiments of the present disclosure, the adjusted-weight of each normalized-score may be calculated by having the normalized-score multiplied by a multiplicative inverse of the sum of the normalized-score of each metric in the plurality of metrics.

Furthermore, in accordance with some embodiments of the present disclosure, when the text-processing NLP module identifies a context of the summary-text, the adjusted-weight of each normalized-score is determined by the identified context of the summary-text.

### BRIEF DESCRIPTION OF THE DRAWINGS

In order for the present disclosure, to be better understood and for its practical applications to be appreciated, the following Figures are provided and referenced hereafter. It should be noted that the Figures are given as examples only and in no way limit the scope of the disclosure. Like components are denoted by like reference numerals.

FIGS. 1A-1B schematically illustrates a high-level diagram of a computerized-system for comprehensive text summarization quality assessment with rank-based normalization and weighted hierarchical ranking strategy;

FIG. 2 shows aggregation based on weighted hierarchical ranking strategy, in accordance with some embodiments of the present disclosure;

FIGS. 3A-3B are a schematic flowchart of a computerized-method for comprehensive text summarization quality assessment with rank-based normalization and weighted hierarchical ranking strategy, in accordance with some embodiments of the present disclosure;

FIG. 4 is a table showing metrics and a score, a normalized score and assigned weight for each metric, in accordance with some embodiments of the present disclosure;

FIG. 5 is an example of an original text and generated summary-text, in accordance with some embodiments of the present disclosure;

FIG. 6 schematically illustrates a high-level diagram of quality evaluation with reference and distribution workflow, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Text summarization has witnessed considerable advancements in recent years, driven by the increasing demand for automated content summarization across various domains. While several existing solutions and technologies have attempted to address the challenges associated with text summarization quality assessment, they often exhibit limitations and fail to provide comprehensive, context-aware evaluations.

Many existing solutions for text summarization quality assessment rely on manual evaluation tools. These tools involve human annotators who assess the quality of summaries based on various criteria, such as informativeness, coherence, and fluency. While manual evaluation provides valuable insights into summary quality, it is labor-intensive, expensive, and prone to inter-annotator variability. Existing tools, such as the Pyramid method and the Automated Machine Translation (AMT)-based evaluation, attempt to mitigate these challenges but require manual intervention and do not provide an automated approach.

Several automated evaluation metrics have been proposed in text summarization, including ROUGE, BLEU, METEOR, and others. These metrics assess the quality of summaries by comparing them to reference summaries using various linguistic and statistical measures. While these metrics offer automation and scalability, they do not capture nuanced aspects of summary quality, such as coherence and relevance.

Metrics like ROUGE, BLEU, and METEOR primarily rely on surface-level analysis and textual comparisons, such as n-gram overlap or lexical similarity. They measure how many words or phrases in the summary match those in a reference summary. However, this approach is effective for assessing basic similarity, but does not delve into the deeper structure or meaning of the text.

Furthermore, these metrics do not account for the context within which the text is written. Coherence and relevance are heavily dependent on understanding the broader context of the text, including the flow of ideas and the way information is structured and presented. Additionally, these metrics may not provide context-aware assessments essential for different application domains.

Supervised machine learning approaches have been applied to text summarization quality assessment. These methods involve training models on labeled datasets, where human experts assign quality scores to summaries. Features extracted from the summaries, such as n-gram overlap and semantic similarity, are used to predict summary quality. While these approaches provide automation, they require substantial labeled data and may not adapt well to varying summarization contexts.

Unsupervised and semi-supervised techniques, including topic modeling and graph-based algorithms, have been explored to assess text summarization quality. These methods attempt to identify coherent and informative summaries without relying on extensive labeled data. However, they may lack precision and struggle to account for context-specific requirements in different applications.

Due to the deficiencies of existing solutions and technologies in the field of text summarization quality assessment, there is a need for a comprehensive and automated technical solution that will combine the advantages of rank-based normalization and weighted hierarchical ranking strategies and provide a more accurate, scalable, and context-aware method for evaluating text summarization quality.

The text summarization quality assessment field presents several persistent challenges that hinder the accurate and context-aware evaluation of summary outputs. One of the foremost challenges in text summarization quality assessment is the inherent subjectivity of human judgment. Individuals may have varying preferences and expectations when evaluating summary quality, leading to inter-annotator variability. This subjectivity can make manual assessment methods less reliable and hinder the establishment of a consistent evaluation framework.

Another challenge of existing evaluation metrics, both manual and automated, is that existing evaluation metrics often focus on specific aspects of summary quality, such as linguistic similarity or informativeness. However, a comprehensive assessment should consider multiple dimensions, including coherence, fluency, relevance to the source text, and domain-specific requirements. The absence of holistic evaluation metrics limits the ability to provide a complete picture of the summary quality.

Yet another challenge, is that text summarization tasks vary widely in content, domain, and user requirements. What constitutes a high-quality summary in one context may differ significantly from another. Existing solutions often struggle to adapt to these varying contexts, leading to assessments that do not adequately consider the specific needs of the users or applications.

For example, News Article vs. Medical Research Paper. The News Article Summarization content focus is to capture the most newsworthy elements, like the key event, important figures involved, and the basic who, what, when, where, and why, whereas the Medical Research Paper Summarization should accurately reflect complex information, including the research question, methodology, key findings and implications. The user requirements for the News Article summarization are that the audience generally seeks a quick, easily digestible overview and the summary should be engaging and capture the main point of the article in a few sentences, whereas the Medical Research Paper Summarization the target audience is primarily medical professionals or researchers, that requires a summary that is detailed and precise, conveying the scientific nuances of the paper. For the News Article Summarization, the quality measures are clarity, brevity, and the ability to convey the central news story effectively and the use of attention-grabbing language might be appreciated, whereas the Medical Research Paper Summarization the quality Measures are accuracy, comprehensiveness, and the use of technical language are vital. The summary must represent the research without oversimplification.

Therefore, a text generation model with an algorithm effective in summarizing news articles may not perform well with medical research papers. While brevity and engagement are key in news summaries, detail and accuracy are paramount in medical summaries. The existing solutions of text generation model may not have the flexibility to switch criteria based on these vastly different user needs and content types. A text generation model with a news summary algorithm might oversimplify a medical paper, or a medical summary algorithm might provide overly detailed news summaries. What is considered high-quality in one domain, e.g., engaging language in news, might be irrelevant or even undesirable in another, e.g., in the precise, technical context of medical research. This example demonstrates the complexity of text summarization across different domains and the need for advanced, context-aware solutions with an ability to adapt the assessment of generated summary and accordingly the generation strategies of the text generation model to meet the diverse requirements.

Yet another challenge, is the limited scalability of manual evaluation, as manual evaluation methods involving human annotators are resource-intensive and not scalable to large datasets or real-time summarization systems. The need for expert annotators and the time required for manual evaluation impose practical limitations on using such methods in many applications.

Yet another challenge, is lack of robustness. Many existing text summarization quality assessment approaches may lack robustness when faced with diverse summarization techniques or linguistic variations. Robustness is essential to ensure the assessment method remains effective across different summarization systems and languages.

Yet another challenge, is ambiguity in summary evaluation. The inherent ambiguity of language and the diversity of content types make it challenging to develop evaluation methods that consistently and accurately distinguish between high-quality and low-quality summaries. Ambiguity arises when multiple summaries can be considered acceptable depending on interpretation.

Therefore, in view of the above-mentioned challenges, there is a need for a technical solution for comprehensively assessing text summarization quality which accounts for subjectivity, context, and robustness.

There is a need for a computerized-method for comprehensive text summarization quality assessment with rank-based normalization and weighted hierarchical ranking.

Artificial Intelligence (AI) is a multidisciplinary field of computer science that aims to create machines capable of mimicking human intelligence. It is designed to enable machines to perform tasks that typically require human intelligence, such as understanding natural language, recognizing patterns, problem-solving, and making decisions. These processes encompass learning, reasoning, self-correction, and the ability to adapt to new information.

Natural Language Generation (NLG) models, as used herein, refers to a subset of NLP models, which transforms structured data into human-readable text, to enable creation of reports, summaries, and other textual content without human intervention. The NLP models are used to automate generation of coherent and fluent text based on certain input data.

Generative AI (GenAI), as used herein, refers to a subset of AI models that focuses on generating new content, such as text, images, music, or other forms of media. These GenAI models, are designed to produce content that is not only syntactically correct, but also semantically meaningful and contextually relevant. GenAI is used for text summarization and in creating high-quality, coherent, and contextually appropriate summaries.

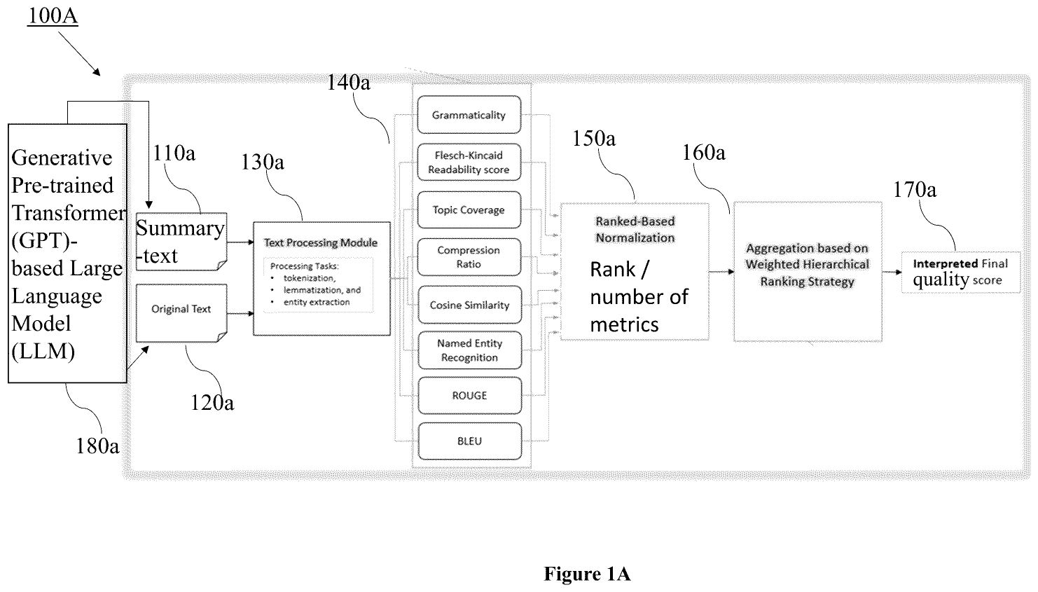

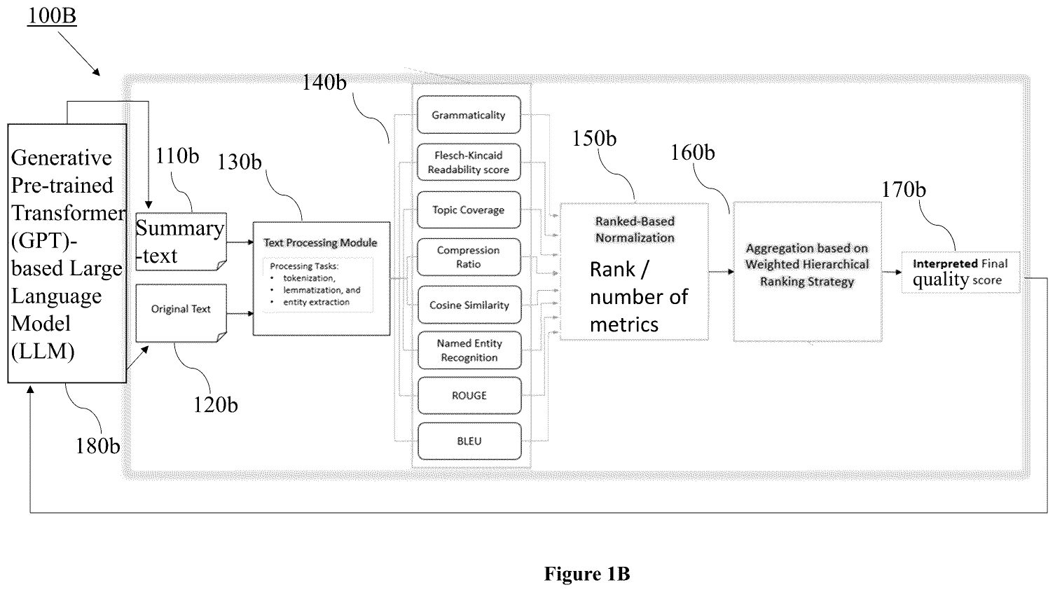

FIG. 1A schematically illustrates a high-level diagram of a computerized-system 100A for comprehensive text summarization quality assessment with rank-based normalization and weighted hierarchical ranking strategy.

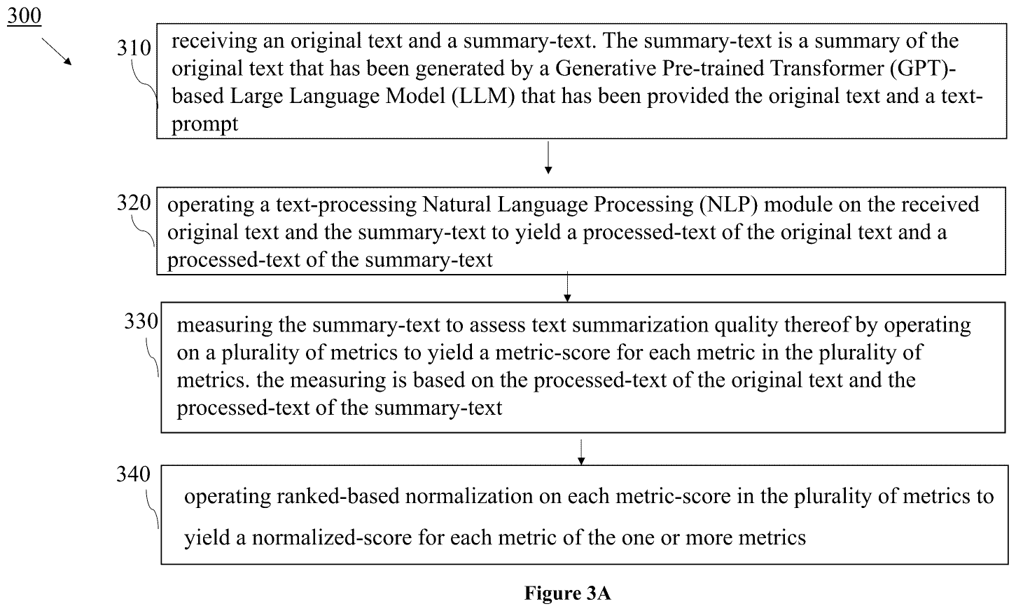

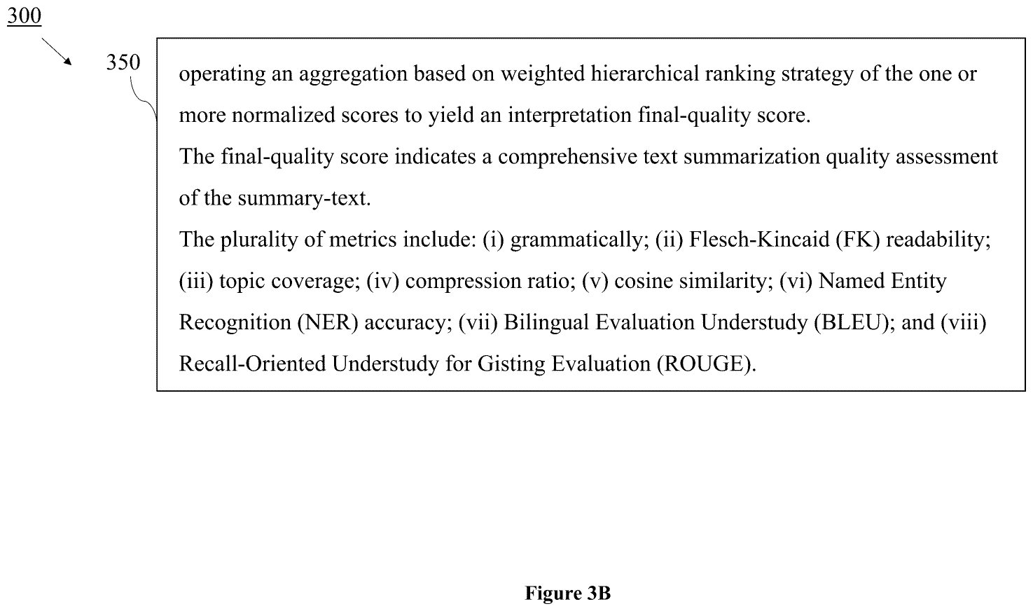

According to some embodiments of the present disclosure, a system, such as system 100A, addresses challenges in existing solutions for text summarization quality assessment. The system 100A addresses the challenges in existing solutions by implementing a computerized-method, such as computerized-method 300 in FIGS. 3A-3B for comprehensive text summarization quality assessment with rank-based normalization and weighted hierarchical ranking strategy. Furthermore, system 100A is automating the intricate processes of text summarization quality assessment.

According to some embodiments of the present disclosure, unlike many traditional quality assessment methods of generated text that rely on a single metric or a limited set of criteria, system 100A employs a diverse range of metrics, each metric contributes a distinct perspective on the quality of a Generative Pre-trained Transformer (GPT)-based Large Language Model (LLM) generated summary-text from the original text. The multiplicity of evaluation metrics, e.g., the plurality of metrics 140a ensures a holistic and nuanced understanding of the generated summary-text quality.

According to some embodiments of the present disclosure, the strength of LLMs lies in their ability to deeply understand the nuances, semantics, and intricacies of human language. By leveraging this understanding, system 100A by providing a comprehensive text summarization quality assessment with rank-based normalization and weighted hierarchical ranking strategy via the calculated interpreted final quality score 170a, may aid in producing summaries that capture the original content's essence and maintain its context, coherence, and fluency.

According to some embodiments of the present disclosure, GPT-based LLM 180a are inherently adaptable. They can adjust their summarization strategies based on the nature of the original content, e.g., original-text 120a, the intended audience, and the specific requirements of the summarization task. For example, as indicated in the provided text-prompt. This adaptability ensures that the generated summaries align with the intended purpose and resonate with the target audience.

According to some embodiments of the present disclosure, one of the hallmarks of LLMs is their ability to learn and refine their knowledge continuously. As the GPT-based LLM 180a that provides system 100A the original text 120a and the summary-text 110a, encounters more diverse content and receives feedback details via a user, that receives it and implements a modification in the GPT-based LLM 180a or in the text-prompt, the GPT-based LLM 180a can adjust their parameters and strategies, ensuring that the quality and relevance of the summaries improve over time.

According to some embodiments of the present disclosure, GPT-based LLM 180a are adept at handling complex linguistic structures, idiomatic expressions, and cultural nuances. This capability ensures the summaries, such as summary-text 110a, are syntactically correct, semantically rich, and culturally appropriate.

According to some embodiments of the present disclosure, LLMs offer unparalleled scalability and performance due to their vast training data and sophisticated architectures. They can handle large volumes of text, produce summaries at scale, and ensure consistent quality across diverse content types and domains.

According to some embodiments of the present disclosure, system 100A may provide a comprehensive text summarization quality assessment, e.g., interpreted final-quality score 170a, by using rank-based normalization and weighted hierarchical ranking strategy. An interpreted final-quality score 170a may be calculated for a summary-text 110a, that has been generated by applying a Generative Pre-trained Transformer (GPT)-based Large Language Model (LLM) 180a on the original text 120a using a text-prompt. For example, “Please summarize paragraph 3 that appears in the attached document on page 8. Make this summary concise and precise”. In another example, “Based on the insights in the list below, please generate recommendation for the user on how to operate in the next week”.

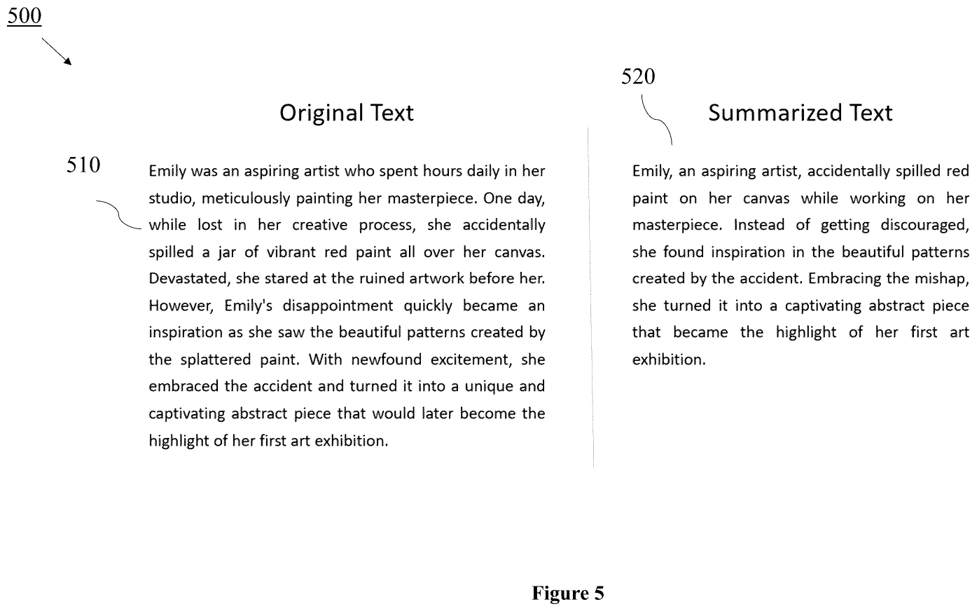

According to some embodiments of the present disclosure, the interpreted final-quality score 170a represents the final aggregated quality score for the generated text, i.e., summary-text 110a and 520 in FIG. 5 and it is used as a quality assessment for the summary-text 110a as a summary of the original text 120a. Its primary purpose is to provide a single, unified quality score that summarizes the overall quality of the generated text by a Generative Pre-trained Transformer (GPT)-based LLM 180a that has been provided the original text 120a and a text-prompt, by considering the contributions of different quality metrics, i.e., the plurality of metrics 140a, and their related scores weighted according to their importance.

According to some embodiments of the present disclosure, the interpreted final-quality score 170a may be used as quality ranking to rank different generated texts, such as summary-text 110a or to rank different models based on their overall quality. For example, use it to compare different text generation systems and determine which one produces higher-quality outputs.

According to some embodiments of the present disclosure, the interpreted final-quality score 170a may be used for threshold determination by establishing a threshold value for the interpreted final-quality score 170a to categorize generated text, e.g., summary-text 110a and 520 in FIG. 5, as acceptable or unacceptable quality. Summary texts with scores, e.g., the interpreted final-quality score 170a above the threshold may be considered of sufficient quality, while those below the threshold may be flagged as low quality.

According to some embodiments of the present disclosure, the interpreted final-quality score 170a may be used for continues monitoring. The interpreted final-quality score 170a may be used as a continuous monitoring metric to track the quality of generated text over time by regularly assessing and recording scores, such as interpreted final-quality score 170a, to identify trends and improvements in text generation quality.

According to some embodiments of the present disclosure, the interpreted final-quality score 170a may be further used for benchmarking and research. Researchers and practitioners in the field of NLP may use the interpreted final-quality score 170a, as a benchmarking metric to evaluate the performance of different quality assessment systems.

According to some embodiments of the present disclosure, the variability in the output of GPT-based LLM 180a, where even the same text-prompt can yield different summary-texts, presents a challenge in determining when a text-prompt needs modification for a better-quality summary. The following key indicators and strategies may assess as to when a text-prompt requires changes. First, consistent deviation from desired content or style. If the summaries regularly miss key information, include irrelevant details, or fail to match the desired style, formal, informal, technical, etc., it may indicate that the text-prompt is not adequately guiding the model, such as GPT-based LLM model 180a.

According to some embodiments of the present disclosure, the text-prompt that is provided to the GPT-based LLM 180a might need refinement to more explicitly specify the required content and style. Second, lack of coherence or logical flow. If the summaries often lack a coherent structure or logical progression of ideas, this could suggest that the text-prompt is not effectively directing the GPT-based LLM 180a to maintain narrative continuity. Modifying the text-prompt to include cues for a coherent structure could help.

According to some embodiments of the present disclosure, third key indicator that may assess as to when a text-prompt requires changes is inconsistency in quality across different attempts. If using the same text-prompt results in varying levels of quality in the text-summaries, it may be necessary to analyze the differences in outcomes to understand what aspects of the text-prompt lead to better results. This analysis can guide specific modifications to the prompt.

According to some embodiments of the present disclosure, fourth key indicator that may assess as to when a text-prompt requires changes, feedback from users or quality assessment tools. Regular feedback from users or automated quality assessment tools can highlight shortcomings in the summaries. If feedback consistently points to specific issues, the prompt may need adjustments to address these areas. Fifth key indicator that may assess as to when a text-prompt requires changes, performance metrics analysis. If the system includes a mechanism for scoring summary quality, like the interpreted final-quality score mentioned in your patent disclosure, consistently low scores in certain areas, such as relevance, coherence, accuracy, etc., can signal the need for prompt modification.

According to some embodiments of the present disclosure, sixth key indicator that may assess as to when a text-prompt requires changes, comparative analysis with reference summaries. Comparing the model-generated summaries with high-quality reference summaries can reveal gaps in content coverage, style, or other aspects. These gaps can guide how the prompt should be altered. Seventh key indicator that may assess as to when a text-prompt requires changes, experimentation and iterative refinement. Sometimes, determining the need for prompt modification requires experimentation. Making incremental changes to the prompt and observing the resulting changes in summary quality can provide insights into what works best. And eighth key indicator that may assess as to when a text-prompt requires changes, domain-specific requirements. If the summaries for texts from certain domains, like legal, medical, technical, are not meeting the expected standards, the prompt might need adjustments to cater more effectively to the specific requirements of these domains.

According to some embodiments of the present disclosure, system 100A may receive an original text 120a, for example original text 510 in FIG. 5 and a summary-text 120a, for example 520 in FIG. 5, that is a summary of the original text. The summary-text has been generated by a text generation model, such as GPT-based LLM 180a that has been provided the original text 120a and a text-prompt. Each text-prompt that is provided and used by the GPT-based LLM 180a, may yield a different summary-text 110 and also same text-prompt used by the GPT-based LLM 180a may yield a different summary-text.

According to some embodiments of the present disclosure, a text-processing Natural Language Processing (NLP) module 130a may be operated on the received original text and the summary-text to yield a processed-text of the original text and a processed-text of the summary-text. The NLP module 130a provides in the processed-text of the of the original text and a processed-text of the summary-text, semantic understanding, contextual analysis, inference, and coherence, as well as key element identification. When the NLP module 130a processes the original text 120a and summary-text 110a, the context of the summary-text 110a may be determined. The analysis of the text-processing NLP module 130a further includes semantic and contextual understanding, which contributes to the context determination. The semantic understanding and the context of the summary-text make a comparison of the summary-text with a reference summary redundant.

According to some embodiments of the present disclosure, the higher-level understanding and analysis of the original text and summary-text for semantics, context, inference, and coherence may be handled by advanced NLP components and models, such as contextual language models, semantic analysis systems, inference engines, and coherence models. These components work together to provide a deeper and more nuanced understanding of the text, going beyond basic structural processing.

According to some embodiments of the present disclosure, deep semantic understanding, contextual analysis, inference, and coherence may be achieved through complex NLP models and algorithms that build upon the foundational processes of tokenization and lemmatization. These might include models for semantic analysis, context-aware algorithms, and inference engines that can understand and interpret the text at a deeper level.

According to some embodiments of the present disclosure, when the text-processing NLP module 130a identifies a context of the summary-text, the adjusted-weight of each normalized-score may be determined by the identified context of the summary.

According to some embodiments of the present disclosure, the text-processing NLP module 130a may prepare and structure the data by: (i) operating tokenization of the received original text and the summary-text to yield a plurality of tokens; (ii) operating lemmatization of each token in the plurality of tokens; and (iii) operating Named Entity Recognition (NER) to extract entities by classifying each token in the plurality of tokens into a category in predefined categories.

According to some embodiments of the present disclosure, tokenization relates to the process of breaking down text into smaller units called tokens. Tokens can be words, phrases, symbols, or any meaningful elements in the text. For example, the sentence “Natural Language Processing is fascinating” would be tokenized into individual words like “Natural,” “Language,” “Processing,” “is,” and “fascinating.” It is a crucial first step in NLP as it helps in simplifying the text analysis by converting a complex sentence into manageable pieces which later on allows algorithms to better understand the structure of sentences and the meaning of the text.

According to some embodiments of the present disclosure, lemmatization relates to the process of reducing a word to its base or root form, known as the lemma. It involves the use of vocabulary and morphological analysis to remove inflectional endings and return the base or dictionary form of a word, which is usually a proper word. For example, the words “running,” “ran,” and “runs” would all be lemmatized to “run”. Lemmatization is used to group together different inflected forms of a word so they can be analyzed as a single item, identified by the word's lemma. This is useful for the purposes of text analysis to ensure that words with the same root are treated as the same word, improving the accuracy of various NLP tasks.

According to some embodiments of the present disclosure, NER, i.e., entity extraction is the process of identifying and classifying key elements in text into predefined categories, such as the names of persons, organizations, locations, expressions of times, quantities, monetary values, percentages, etc. For example, in the sentence “Google was founded in California,” “Google” would be classified as an organization and “California” as a location. NER contributes to key element identification and some level of semantic understanding.

According to some embodiments of the present disclosure, the summary-text may be measured by a plurality of metrics 140 to assess text summarization quality. The plurality of metrics 140a may be operated to measure the summary-text 110 and provide a metric-score. The measuring may be based on the processed-text of the original text and the processed-text of the summary-text, yielded by the text-processing NLP module 130a.

According to some embodiments of the present disclosure, the plurality of metrics 140a includes: (i) grammatically; (ii) Flesch-Kincaid (FK) readability; (iii) topic coverage; (iv) compression ratio; (v) cosine similarity; (vi) Named Entity Recognition (NER) accuracy; (vii) Bilingual Evaluation Understudy (BLEU); and (viii) Recall-Oriented Understudy for Gisting Evaluation (ROUGE).

According to some embodiments of the present disclosure, ranked-based normalization 150a may be operated on each metric-score in the plurality of metrics to yield a normalized-score for each metric-score of each metric in the plurality of metrics 140a.

According to some embodiments of the present disclosure, the ranked-based normalization 150a may include: (i) sorting the plurality of metrics by the measured metric-score of each metric in the plurality of metrics to yield a sorted list of metrics; (ii) assigning a rank to each metric based on a position of the metric in the sorted list of metrics; and (iii) dividing each rank by a total number of metrics in the list of metrics.

According to some embodiments of the present disclosure, an aggregation based on weighted hierarchical ranking strategy 160a of the normalized scores may be operated to yield an interpreted final-quality score 170a, which indicates a comprehensive text summarization quality assessment of the summary-text 110a.

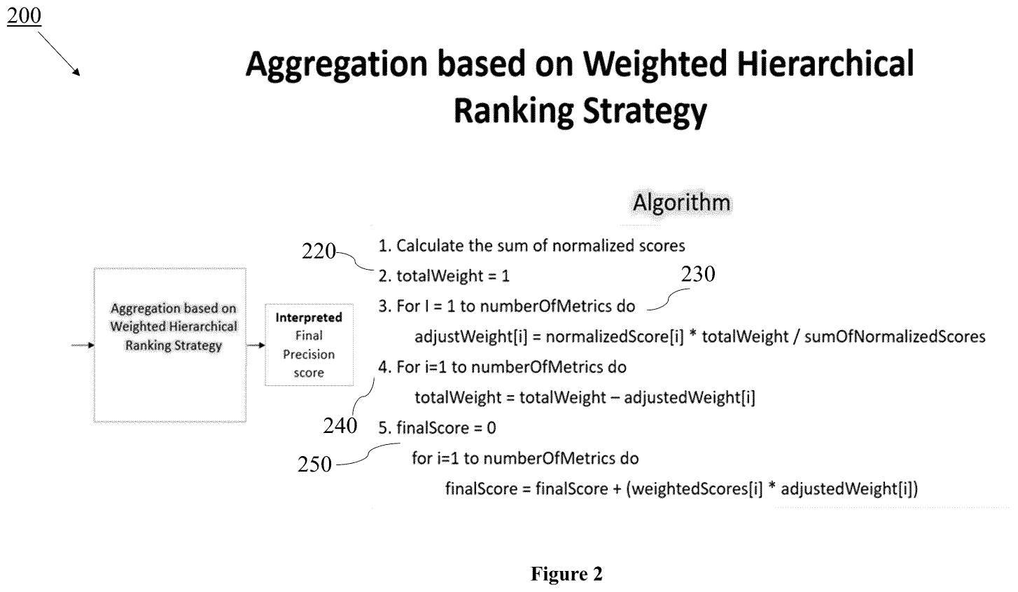

According to some embodiments of the present disclosure, the aggregation based on weighted hierarchical ranking strategy of the normalized scores may include: (i) calculating a sum of the normalized-score of each metric in the plurality of metrics; (ii) for each normalized-score of the plurality of metrics assigning an adjusted-weight; and (iii) calculating the interpreted final-quality score by summing weighted normalized scores. A weight of each normalized-score may be the assigned adjusted-weight. The aggregation based on weighted hierarchical ranking strategy may be implemented, as shown in FIG. 2.

According to some embodiments of the present disclosure, the adjusted-weight of each normalized-score may be calculated by having the normalized-score multiplied by a multiplicative inverse of the sum of the normalized-score of each metric in the plurality of metrics.

According to some embodiments of the present disclosure, grammatically is a metric that provides a metric-score which is an assessment of the grammatical correctness of the summarized text, e.g., summary-text 110a. Flesch-Kincaid (FK) readability is a metric that provides a metric-score that is a measurement of the readability of the summarized text. For example, technical documents may receive a low score based on this metric. Topic coverage is a metric that provides a metric-score that evaluates how well the summarized text captures the main ideas and topics from the original text 120a, e.g., original text 510 in FIG. 5.

According to some embodiments of the present disclosure, compression ratio is a metric that provides a metric-score which is a calculation of the ratio of the summarized text's length compared to the original text's length, indicating the level of compression achieved. Cosine similarity is a metric that provides a metric-score a measurement of the similarity between the original and the summarized text by using vector representation. Named Entity Recognition (NER) accuracy is a metric that provides a metric-score that is an identification and evaluation of the presence of named entities, such as persons, organizations, and locations, in the summarized text.

According to some embodiments of the present disclosure, Bilingual Evaluation Understudy (BLEU) is a metric that provides a metric-score that is a measurement of the n-gram overlap between the summarized text, e.g., summary-text 110 and the original text 120a. Recall-Oriented Understudy for Gisting Evaluation (ROUGE) is a set of metrics that provides a metric-score which is an assessment of overlap between the summarized text and the original text. The set of metrics include ROUGE-1, ROUGE-2 and ROUGE-L.

According to some embodiments of the present disclosure, ROUGE-1 as used herein, refers to a metric evaluates the overlap of unigrams i.e., individual words, between the summary-text and the original text, highlighting basic content similarity. ROUGE-2 as used herein, refers to a metric that assesses the overlap of bigrams e.g., two consecutive words, between the summary-text 110a and the original text 120a, offering insights into the preservation of phrase-level information. ROUGE-L as used herein, refers to a metric that measures the longest common subsequence between the summary-text 110a and the original text 120a, focusing on the evaluation of sentence-level structure and coherence.

According to some embodiments of the present disclosure, the inclusion of the plurality of metrics 140a captures diverse aspects of text quality, including readability, coherence, linguistic correctness, relevance to the topic, and more and the breadth assessment dimensions demonstrates its robustness and adaptability in evaluating text across various domains and purposes.

According to some embodiments of the present disclosure, different text contexts can be better evaluated by specific metrics within the plurality of metrics 140a, each focusing on distinct aspects of text quality. For example, the following two contrasting text contexts, academic research paper and online blog post may be evaluated to identify which metrics from the plurality of metrics 140a may be identified to be most suitable for each text context.

According to some embodiments of the present disclosure, the academic research paper may have a key quality aspect of linguistic correctness and relevance to the topic. The suitable metric may be a metric focusing on linguistic correctness and domain-specific relevance, such as grammatically metric, which assesses grammatical correctness. This could be a specialized tool that evaluates the use of technical terminology, the accuracy of references, and the alignment of the summary with the core research questions and findings of the paper. Such a metric might analyze the precision of language and the inclusion of key research elements, ensuring the summary is both linguistically correct and topically relevant. Ensuring the highest score in this metric may be operated by adjusting weights in the weighted hierarchical ranking strategy based on the text's context.

According to some embodiments of the present disclosure, the online blog post may have a key quality aspect of readability and coherence. A suitable metric may be a metric emphasizing readability, such as FK readability metric and coherence, such as ROUGE-L metric may be more adequate. The adequate metrics may be ensured by adjusting weights in the hierarchical ranking based on the summary-text intended use. This might involve tools that assess the simplicity of language, sentence structure, and the logical flow of ideas. The goal is to ensure that the summary is easy to understand and follows a coherent narrative, making it accessible to a general audience.

According to some embodiments of the present disclosure, as to the academic research paper in this context, the complexity and accuracy of language are paramount. The metric should be capable of handling complex, domain-specific terminology and concepts, ensuring that the summary captures the essence of the paper without oversimplification. As to the online blog post, the focus is on making the content engaging and easily digestible for a broad audience. The metric should evaluate how well the summary conveys the main points in a clear, concise, and engaging manner, with an emphasis on maintaining a conversational tone and a coherent flow.

According to some embodiments of the present disclosure, by operating the plurality of metrics 140a that are tailored to the specific requirements of different text contexts, the evaluation process becomes more effective, ensuring that the summaries not only meet general standards of quality but also cater to the unique demands of each type of content. This demonstrates the adaptability and robustness of a system equipped with a diverse range of metrics for text quality assessment.

According to some embodiments of the present disclosure, the diverse set of metrics in the plurality of metrics 140a, which encompasses both quantitative and qualitative aspects, mitigates the risk of favoring any specific characteristic of the text, thus reducing potential bias in the overall score and reinforces objectivity and reliability of the interpreted final-quality score 170aprovided by the system 100A.

According to some embodiments of the present disclosure, the combination of a diverse set of metrics adds complexity to system 100A and is not obvious to a person skilled in the art, as each metric in the plurality of metrics 140a requires computational resources, and more metrics mean more processing power and time. A practitioner might be concerned about the efficiency and scalability of the system, especially in real-time applications. By operating the text-processing NLP module and the weighted hierarchical ranking strategy system 100A overcomes the efficiency and scalability concerns.

According to some embodiments of the present disclosure, the combination of a diverse set of metrics might concern a person having ordinary skills in the art as to the risk of redundancy and diminishing returns. There might be a belief that beyond a certain point, adding more metrics could lead to redundancy and not significantly improve the quality assessment of the summary-text. This is based on the principle of diminishing returns, where the benefit of each additional metric becomes progressively smaller.

According to some embodiments of the present disclosure, moreover, the combination of a diverse set of metrics may raise a challenge of integration and harmonization. Integrating various metrics, especially those that assess qualitatively different aspects of text, like readability vs. factual accuracy, can be challenging. It requires an approach, such as the rank-based normalization and the aggregation based on weighted hierarchical ranking strategy, as system 100A implements, to balance and harmonize these metrics to produce a coherent overall score.

According to some embodiments of the present disclosure, system 100A may raise difficulty in interpretation and actionability. With a large number of metrics, interpreting the results, e.g., interpreted final-quality score 170a and understanding how to act on them to improve text quality can become more complex. A simpler system might be perceived as more user-friendly and actionable.

According to some embodiments of the present disclosure, different metrics in the plurality of metrics 140a may sometimes provide conflicting feedback, making it difficult to decide how to adjust the summary-text generated by the GPT-based LLM to improve the overall score, e.g., interpreted final-quality score 170a. A practitioner might opt for a more streamlined set of metrics to avoid such conflicts.

According to some embodiments of the present disclosure, practitioners might design systems with specific use cases in mind, where only a subset of metrics is relevant. They might not consider the need for a comprehensive set that applies to a wider range of contexts.

According to some embodiments of the present disclosure, there may be domain-specific requirements when designing a system to assess text quality. Therefore, certain domains might prioritize specific aspects of text quality, e.g., factual accuracy in news reporting, leading to a focus on metrics that assess these aspects, while overlooking others, in contrast to the plurality of metrics 140a.

According to some embodiments of the present disclosure, by providing an interpreted final-quality score 170a to a summary-text 110a that has been generated by Generative Artificial Intelligence (GenAI), such as GPT-based LLM, system 100A leverages techniques to produce or enhance text summarizations. By analyzing the original text 120a and understanding its nuances, e.g., scoring of each metric in the plurality of metrics 140a, which are rank-based normalized and then aggregated by a weighted hierarchical ranking strategy, GenAI models can generate concise summaries that capture the essence of the content while maintaining its context and intent.

According to some embodiments of the present disclosure, GenAI often relies on deep learning architectures, such as Generative Adversarial Networks (GAN) s and Transformer-based models. These architectures enable system 100A to handle complex linguistic structures, ensuring that the generated summaries are of high quality and free from inconsistencies or inaccuracies.

According to some embodiments of the present disclosure, transformer-based models are a type of deep learning model that are particularly effective in handling natural language processing tasks, including text summarization. In system 100A, they likely form the core of the text generation process. These models excel in understanding context and generating coherent, relevant text. They process entire sequences of words, rather than one word at a time, allowing them to capture long-range dependencies and nuanced linguistic structures in the original text and summary-text.

According to some embodiments of the present disclosure, by using the interpreted final-quality score 170a of system 100, the Transformer-based models, e.g., GPT-based LLM, may generate summaries that are contextually accurate and linguistically coherent. They help ensure that the summaries maintain the essence of the original text 120a and are free from logical inconsistencies.

According to some embodiments of the present disclosure, Generative Adversarial Networks (GAN) s are typically used in AI to generate content that is indistinguishable from real, human-generated content and may be used to refine the generated summaries.

According to some embodiments of the present disclosure, a GAN commonly comprising two parts: a generator, which creates summaries and a discriminator, which evaluates them. The discriminator's job is to distinguish between human-generated and AI-generated text.

According to some embodiments of the present disclosure, the iterative process of generation and discrimination in GANs pushes the system toward producing high-quality text. The generator learns to create increasingly accurate and coherent summaries, while the discriminator ensures that these summaries are free from inconsistencies and inaccuracies.

According to some embodiments of the present disclosure, these architectures likely work together to produce and refine text summaries. The Transformer-based models generate initial drafts of the summaries, leveraging their ability to understand and process complex language structures. GANs might then be employed to further refine these summaries, with the generator proposing improvements and the discriminator evaluating their quality. This process helps in ironing out any inaccuracies or inconsistencies. The end result is a summary that not only captures the key points of the original text but does so in a manner that is coherent, contextually appropriate, and linguistically sound.

According to some embodiments of the present disclosure, this integration of Transformer-based models and GANs in system 100A represents a sophisticated approach to AI-driven text summarization, harnessing the strengths of both architectures to produce high-quality summaries.

According to some embodiments of the present disclosure, the GenAI models, e.g., GPT-based LLM 180a that provides the summary text 110a to system 100A are likely designed to understand and interpret the context in which the original text is situated. This involves analyzing aspects, such as the subject matter, the intended audience, and the purpose of the text.

According to some embodiments of the present disclosure, by recognizing the context of the original text, the models can adjust the style, tone, and focus of the summary-text to match it. For instance, a summary for a technical audience might include more jargon and detail, while one for a general audience would be simpler and more concise.

According to some embodiments of the present disclosure, the GPT-based LLM model 180a may analyze the nature of the original text 120a, identifying key themes, important information, and the overall structure. This analysis enables to determine what information is most crucial to include in the text-summary 110a and how to best structure it. For example, summarizing a scientific paper would require focusing on research findings and methodologies, whereas a news article summary might prioritize the main event and its implications.

According to some embodiments of the present disclosure, GenAI models, such as GPT-based LLM 180a are trained to ensure that the generated summary-text is contextually relevant and bring a sense of novelty. This ensures that the summaries are not mere reductions of the original content but offer a fresh perspective, making them more engaging and impactful.

According to some embodiments of the present disclosure, by ensuring that the generated summaries are contextually relevant, a key challenge in text summarization, which is retaining the essential message and tone of the original content is being addressed. This means that the summaries produced are not only concise but also accurately reflect the main ideas and context of the source material.

According to some embodiments of the present disclosure, the comprehensive text summarization quality assessment with rank-based normalization and weighted hierarchical ranking strategy in the summaries adds value beyond mere content reduction. This approach makes the summaries more engaging and impactful, as they provide a fresh perspective rather than just a condensed version of the original text. Such an approach can be particularly beneficial in applications where reader engagement is important, like in news media, content marketing, or educational materials.

According to some embodiments of the present disclosure, in many scenarios, users seek summaries that not only condense information but also offer new insights or highlight different aspects of the original content. By training the GenAI models to introduce an element of novelty, based on the comprehensive text summarization quality assessment with rank-based normalization and weighted hierarchical ranking strategy, the GenAI meets these user expectations more effectively.

According to some embodiments of the present disclosure, unlike simpler extraction-based summarization methods, which might just pick out key sentences without altering or rephrasing them, system 100A approach indicates a more sophisticated processing capability, likely involving understanding, interpretation, and rearticulation of the original text, which may be extrapolated from the interpreted final-quality score 170a.

According to some embodiments of the present disclosure, rank-based normalization method assigns ranks to the metric scores based on their relative position in a sorted order instead of using their absolute value.

According to some embodiments of the present disclosure, rank-based normalization 150a may be operated for each score of the plurality of metrics to yield a normalized-score for each metric in the plurality of metrics 140a by rank-based normalization methods, such as Rankit or Quantile normalization, which sort the metrics scores and assign normalized values based on their ranks, such that the ranks are scaled between ‘0’ and ‘1’. This technique ensures that each metric-score is assigned a normalized value that is representing its relative position in the dataset.

According to some embodiments of the present disclosure, a rank-based normalization method may sort the data points in the dataset, i.e., the scores of the plurality of metrics that have been operated on the processed summary-text, in ascending order and then assign a rank to each metric-score based on the metric-score relative position. The metric-score having the smallest value may be assigned the lower rank of ‘1’ and then the next metric score may be assigned the rank of ‘2’ and so on. In case there are multiple metric-scores having the same value the assigned rank may be the average rank. Once the ranks are assigned to the metric scores, they are normalized by dividing each rank by the total number of the plurality of metrics, which may scale the ranks to be between ‘0’ and ‘1’.

According to some embodiments of the present disclosure, the rank-based normalization 150a is resistant to outliers in the metric-scores, as a single very high or very low value of a metric score may not affect the relative ranking of other values. Furthermore, it makes no assumption about the data distribution, and it provides standardized scale which is useful when combining data measured in different units or scales.

According to some embodiments of the present disclosure, the rank-based normalization also facilitates fair comparison by placing all metrics scores on a common scale, ranked-based normalization ensures fair and unbiased comparison.

According to some embodiments of the present disclosure, the interpreted final-quality score 170a provides a comprehensive evaluation for the summary-text 110a based on a broad spectrum of metrics, i.e., the plurality of metrics 140a. The evaluation is designed to provide a holistic understanding of the quality of the summarized text, considering different aspects like readability, topic coverage, similarity, and grammaticality.

According to some embodiments of the present disclosure, the process of the interpreted final-quality score calculation, in which weights are assigned based on rank rather than absolute values of the metric scores is advantageous because it avoids biases arising from metrics with high or low values. However, it also means that the absolute performance difference between metrics isn't directly considered in the weighting.

According to some embodiments of the present disclosure, system 100A, by calculating the interpreted final-quality score 170a and using weights assigned based on rank rather than the absolute values of metric scores, has the following set of implications. (i) reduced metric bias. by ranking metrics instead of using their absolute values, the system reduces the potential bias that could arise when certain metrics inherently yield higher or lower scores. This approach ensures a more balanced and fair assessment of the text's quality, where no single metric disproportionately influences the overall score. (ii) implications for text quality improvement. For users or developers looking to improve text quality, this ranking-based approach might require a more nuanced understanding of the results. They may need to delve deeper into individual metric scores to identify and address specific areas of improvement, rather than relying solely on the overall rank-based score. (iii) strategic focus in model training. In terms of training and refining AI models for text generation, this system 100A suggests a more holistic approach. Rather than focusing on maximizing or minimizing specific metric scores, the emphasis is on achieving a balanced performance across all metrics, encouraging the development of well-rounded models. (iv) potential for more equitable model evaluation. System 100A may lead to a more equitable evaluation of different models or algorithms used for text generation. Since the ranking system mitigates the influence of inherently high or low-scoring metrics, it allows for a fairer comparison of models based on their overall performance across a range of quality aspects.

According to some embodiments of the present disclosure, the interpreted final-quality score 170a may be categorized into qualitative bands, such as “Excellent”, “Good,” “Fair”, “Poor”, which may be useful for non-experts that want a high-level understanding of the quality of the summary without delving into individual metrics.

FIG. 1B schematically illustrates a high-level diagram of a computerized-system 100B for comprehensive text summarization quality assessment with rank-based normalization and weighted hierarchical ranking strategy.

According to some embodiments of the present disclosure, system 100B may comprise the same elements as system 100A in FIG. 1A.

According to some embodiments of the present disclosure, the interpreted final-quality score 170b may be used for feedback and improvement. In case of a system for feedback to text generation models, the interpreted final-quality score 170b may be used to guide improvement. Summary texts with lower scores, e.g., interpreted final-quality score 170b can be analyzed to identify which specific quality metrics are contributing to the lower score, helping developers focus on areas that need enhancement.

According to some embodiments of the present disclosure, when using the interpreted final-quality score 170b to guide improvements in text generation models, such as Generative Pre-trained Transformer (GPT)-based Large Language Model (LLM) 180b, there are several key areas where developers can focus their efforts, apart from text-prompt refinement. The interpreted final-quality score 170b may be used as a diagnostic tool to identify weaknesses in their text summarization models and target their efforts towards making meaningful improvements. These areas are critical for enhancing the overall quality and effectiveness of text summarization models.

According to some embodiments of the present disclosure, for example, improving coherence and logical flow. If the text generation model's text-summaries are consistently scoring low in coherence metric, such as ROUGE-L metric, which focuses on sentence-level structure and coherence, developers might need to refine the ability of the GPT-based LLM 180b to understand and maintain the logical flow of ideas. This could involve enhancing the text generation model's understanding of narrative structures and the relationships between different parts of the text.

According to some embodiments of the present disclosure, in another example, low score in relevance metric, such as BLEU metric, which measures n-gram overlap and hence relevance to the original text, may indicate that the generated summaries include irrelevant or redundant information. To enhance relevance and conciseness, efforts can be made to fine-tune the text generation model's capability to identify and focus on the most pertinent content from the source material, ensuring that the summary is concise yet comprehensive.

According to some embodiments of the present disclosure, in yet another example, when the GPT-based LLM 180b struggles with maintaining an appropriate style or tone for different types of texts, to advance language and style adaptation, a low score in a metric, such as Flesch-Kincaid (FK) readability metric, which assesses readability and implicitly style, may indicate to developers to work on the GPT-based LLM 180b ability to adapt its language use. For instance, a more formal tone might be required for academic summaries, while a conversational style could be better for general news articles.

According to some embodiments of the present disclosure, in yet another example, low scores in contextual understanding, which may be reflected in cosine similarity metric, which measures the similarity in vector space, and may indicate how well the summary captures the original text's context, could signal the need for better contextual awareness in the text generation model. Improvements and refining of contextual understanding could be directed towards enabling the text generation model to understand the context in which the text is situated, such as the intended audience, the purpose of the text, and the cultural or domain-specific nuances.

According to some embodiments of the present disclosure, in yet another example, accuracy and factual consistency. In cases where the text generation model's summaries are found to be factually inaccurate or inconsistent with the original text, developers might focus on improving the text generation model's ability to extract and accurately represent key facts and figures from the source material.

According to some embodiments of the present disclosure, in yet another example, if the GPT-based LLM 180b struggles with summarizing complex or technical texts, a low score in a metric such as comparison ratio metric or NER metric may indicate that enhancements might be needed in the ability of the GPT-based LLM 180b, to process and simplify complicated information without losing essential details or introducing inaccuracies.

According to some embodiments of the present disclosure, in yet another example, developing more robust feedback mechanisms that can effectively incorporate user feedback into the text generation model's learning process, thereby continually improving its performance based on real-world usage and evaluations.

According to some embodiments of the present disclosure, in yet another example, reducing inherent biases in the GPT-based LLM 180b and ensuring that it can handle a diverse range of texts and topics effectively, without favoring certain types or styles of content by evaluating the summary-text 110b across diverse metrics, as in the plurality of metrics 140b, thus reducing the likelihood of bias towards certain text types or styles.

According to some embodiments of the present disclosure, different summarization tasks may have different requirements, such as length constraints, focus areas, or desired level of detail. The GenAI models that provide the summary-text of the original text to system 100B can adjust their generation approach based on these task-specific requirements. This means the system can produce a brief, high-level overview for one task or a detailed, comprehensive summary for another.

According to some embodiments of the present disclosure, optionally, system 100B may incorporate feedback loops and learning mechanisms that may allow it to learn from past performance and user input. Over time, the system can refine its approach, becoming more adept at producing summaries that meet users' needs and preferences. The system 100B uses a plurality of metrics 140b to evaluate the quality of the summary-text 110b. By analyzing the scores of these metrics, areas for improvement may be identified and summarization strategies may be adjusted accordingly.

According to some embodiments of the present disclosure, system 100B may benefits from a GenAI-driven feedback loop. As users provide feedback on the quality and relevance of the summarizations, GenAI models use this feedback to refine their generation algorithms. This continuous learning ensures that the quality of the generated summaries improves over time, adapting to evolving standards and user preferences.

According to some embodiments of the present disclosure, optionally, a feedback loop may be implemented that may guide users on when and how to reiterate the text-generation process by the GPT-based LLM 180b using a text-prompt, based on the received interpreted final-quality score 170b.

According to some embodiments of the present disclosure, a threshold-based feedback loop may be implemented by defining a quality-threshold to the interpreted final-quality score 170b. For example, establishing a baseline threshold for acceptably quality of the summary-text 110b. When the interpreted final-quality score 170b may be below the defined quality-threshold, feedback-details may be provided to a user via a computerized-device to modify the text-prompt and receive a regenerated summary-text of the original text from the GPT-based LLM 180b, and then assessing the regenerated summary-text by operating text-processing NLP module 130b through operation of the plurality of metrics 140b and ranked-based normalization of each metric-score 150b and then aggregating the normalized metric-scores based on weighted hierarchical ranking strategy 160b, i.e., a reiteration of the summary-text 110b may be recommended.

According to some embodiments of the present disclosure, optionally, the feedback-details may include the metric-score of each metric in the plurality of metrics 140b, which may provide insights on which specific metrics contributed to a lower interpreted final-quality score 170b, by including a preconfigured number of metrics having lowest metric-score and suggestions for improving these aspects of the summary-text.

According to some embodiments of the present disclosure, in the context of providing feedback based on metric scores to improve text summaries, suggestions may be tailored to address specific weaknesses identified by the lowest-scoring metrics. For example, when a summary-text generated by a text generation model, such as Generative Pre-trained Transformer (GPT)-based Large Language Model (LLM) 180b receives low metric scores in ROUGE-2 which is bigram overlap and also in ROUGE-L, which is longest common subsequence, then the meaning is as follows. Low ROUGE-2 score suggests that the generated summary-text is not effectively capturing key phrases from the original text. Low ROUGE-L score indicates a lack of coherence in terms of sentence structure and sequence alignment with the original text.

According to some embodiments of the present disclosure, for example, the derived suggestions, e.g., feedback details may be to enhance phrase-level accuracy. The suggestion may be to focus on including essential phrases from the original text 120b. This could involve fine-tuning the text generation model to better identify and incorporate key phrases that are central to the original text's meaning.

According to some embodiments of the present disclosure, for example, the derived suggestions, e.g., feedback details may be to improve coherence. The suggestion may be to work on the logical flow and structure of the summary-text. This might include adjusting the text generation model to better understand and replicate the narrative structure of the original text 120b, ensuring that the summary-text maintains a coherent sequence of ideas.

According to some embodiments of the present disclosure, for example, the process of deriving suggestions may be operated by an analysis of the scores of the plurality of metrics 140b. First, a detailed analysis of the specific metrics where the summary scored low is conducted. This analysis identifies the areas where the summary-text 110b is lacking compared to the original text 120b. Then, identifying underlying. Based on the low scores, the specific aspects of summary quality that need improvement are identified. For example, low scores in bigram overlap and sentence-level structure point towards issues in capturing key phrases and maintaining coherence.

According to some embodiments of the present disclosure, suggestions may be tailored to address these identified issues. The process involves understanding how the text generation model works and identifying potential adjustments that could enhance its performance in the weak areas. The suggestions are often backed by data and insights gained from previous outputs of the model and user feedback. This data may help in understanding the patterns and common issues in the model-generated summaries. Expert input, e.g., expert knowledge in linguistics, natural language processing, and the specific domain of the text can also contribute to formulating effective suggestions.

According to some embodiments of the present disclosure, the suggestions may be part of the iterative feedback loop which is an iterative process where they are implemented, tested, and refined based on ongoing feedback and performance metrics.

According to some embodiments of the present disclosure, optionally, resource integration may be implemented by the feedback-details including integrated resources. The integrated resources may include at least one of: (i) style guides; (ii) grammatical rules; and (iii) topic-specific templates.

According to some embodiments of the present disclosure, optionally, when lowest metric scores are of at least one metrics of: grammatically and topic coverage the feedback-details may provide references to relevant resources from website and academic papers, and professional literature.

According to some embodiments of the present disclosure, actionable steps may be provided to users to address the interpreted final-quality score 170b below the preconfigured threshold, such as modifying the text-prompt.

According to some embodiments of the present disclosure, a progress tracking of an improvement of the interpreted final-quality-score 170b may be implemented by the storing of the interpreted final-quality score in a database with related original text, summary-text and the plurality of metrics and corresponding metric-scores, when the interpreted final-quality score 170b of a summary-text 110b is below the preconfigured threshold, previously stored one or more interpreted final-quality scores may be retrieved for the database, and related summary-text and the plurality of metrics and corresponding metric-scores to be presented via a display unit to a user.

According to some embodiments of the present disclosure, details of the interpreted final-quality score of a summary-text that is below the preconfigured threshold, related summary-text, feedback-details and user modifications to the GPT-based LLM 180b to regenerate the summary-text may be stored in a documentation-database. This documentation may be used by users seeking to understand their summary-text refinement process better by reviewing all records of iterations related to an original text and the generated summary-text, in which in each record includes the original text, the generated summary-text, the interpreted final-quality score 170b and the text-prompt provided to the GPT-based LLM 180b. Thus, by reviewing the interpreted final-quality score 170b of each summary-text and related text-prompt, a user may better understand how to refine for a better-quality summary-text.

According to some embodiments of the present disclosure, other than modifying the text-prompt, there are several other aspects that a user can adjust in each iteration to improve the quality of the summary-text generated by a GPT-based Large Language Model (LLM) 180b. These adjustments can help in fine-tuning the GPT-based LLM output to better meet specific requirements and preferences. For example, model parameters. Users might adjust certain parameters of the GPT-based LLM 180b, such as the length of the summary, level of detail, or the degree of abstraction. Tweaking these parameters can significantly change how the GPT-based LLM processes the original text and generates the summary-text.

According to some embodiments of the present disclosure, in another example, via a feedback loop integration users may incorporate specific feedback into the model's training loop. This could involve highlighting particular areas where the summary was lacking, like coherence, relevance, or accuracy and using this feedback to guide the GPT-based LLM's learning process.

According to some embodiments of the present disclosure, in another example, contextual information may be provided by additional context or background information to the text generation model that can improve its understanding and handling of the subject matter, leading to more accurate and relevant summaries.

According to some embodiments of the present disclosure, in another example, domain-specific tuning for summaries related to specialized fields, like legal, medical, or technical texts, users can modify the input to include domain-specific language or concepts, helping the model to generate summaries that are more in line with the norms of those fields.

According to some embodiments of the present disclosure, in another example, adjusting summary style or tone. Depending on the intended use or audience, users might want to alter the style or tone of the summary, e.g., formal, informal, persuasive, descriptive, which can be guided by changing the way the prompt is structured.

According to some embodiments of the present disclosure, in yet another example, source text selection or modification. In some cases, modifying the original text itself, such as by clarifying ambiguities or adding missing information before feeding it to the GPT-based LLM can result in better summaries.

According to some embodiments of the present disclosure, in yet another example, custom training or fine-tuning. Advanced users might engage in custom training or fine-tuning of the GPT-based LLM 180b with specific datasets to enhance its performance in generating summaries for original text of certain types of texts or topics.

According to some embodiments of the present disclosure, in yet another example, post-processing rules or scripts. Implementing post-processing rules or scripts that automatically edit or refine the generated summary based on predefined criteria may also improve the output.

According to some embodiments of the present disclosure, the feedback loop may be optional, such that users may decide whether to reiterate based on the interpreted final-quality score, as there may be situations that speed of process may be prioritized over perfection. When the interpreted final-quality score is below the preconfigured threshold and there is an indication that a feedback-loop is not required, feedback-details are not provided to the GPT-based LLM 180b to receive the regenerated summary-text.

According to some embodiments of the present disclosure, system 100B may provide an adaptive summarization. GenAI models can adjust their generation strategies based on the context, the original content's nature, and the summarization task's specific requirements. This adaptability ensures that the summaries are always aligned with the intended purpose and audience.

According to some embodiments of the present disclosure, in the context of system 100A providing adaptive summarization, the adaptability refers to the ability of GenAI models within the system to tailor their text generation strategies to various contexts and requirements. The following components in system 100B contribute to this adaptability.

According to some embodiments of the present disclosure, the adaptability of system 100B lies in its ability to dynamically adjust its summarization strategies, considering the specific context, content, and requirements of each summarization task. This ensures that the generated summaries are not only accurate and coherent but also appropriately tailored to their intended purpose and audience.

According to some embodiments of the present disclosure, by using the interpreted final-quality score 170b to generate novel and contextually relevant summaries provides summaries that not only focus solely on reducing the length of the content without adding any new perspective or adequately considering the context.

FIG. 2 shows aggregation based on weighted hierarchical ranking strategy 200, in accordance with some embodiments of the present disclosure.

According to some embodiments of the present disclosure, rank-based normalization, such as ranked-based normalization 150a in FIG. 1A and such as ranked-based normalization 150b in FIG. 1B is a method where data points in a dataset, for example, metric-scores of the metrics in the plurality of metrics, such as plurality of metrics 140a in FIG. 1A and such as plurality of metrics 140b in FIG. 1B, are assigned ranks based on their relative positions in the sorted order. Instead of directly using the raw data values of the metric-scores, their ranks are being used. This method is especially useful when there's an interested in the relative ordering of data points rather than their absolute values.

According to some embodiments of the present disclosure, the data points in the dataset may be sorted in ascending order and then rank assignment may be operated by assigning a rank to each data point, e.g., metric-scores based on its position in the sorted dataset. The smallest data point gets a rank of 1, the next smallest gets 2, and so on. Once ranks are assigned, they can be normalized by dividing each rank by the total number of data points, e.g., number of metrics in the plurality of metrics, such as the plurality of metrics 140a in FIG. 1A. The ranks are normalized such that it may scale the ranks to be between ‘0’ and ‘1’.

According to some embodiments of the present disclosure, the rank-based normalization is resistant to outlier. A single very high or very low value won't affect the relative rankings of other values. It is non-parametric, as it makes no assumptions about the data distribution. It is useful when combining data measured in different units or scales, which standardizes scale.

According to some embodiments of the present disclosure, system 100A and system 100B employ an intricate normalization procedure to harmonize the disparate scores obtained from the plurality of metrics 140a in FIG. 1A, scaling them uniformly within the range of ‘0’ to ‘1’, while preserving their relative magnitudes. Following the ranked-normalization operation, an aggregation based on weighted hierarchical ranking strategy, such as aggregation based on weighted hierarchical ranking strategy 160a in FIG. 1A and such as aggregation based on weighted hierarchical ranking strategy 160b in FIG. 1B, is applied. The hierarchical ranking strategy assigns each metric-score an adjusted weight. This orchestrated process facilitates the automated computation of an overarching, interpreted final-quality score 170, encapsulating the quality assessment of the text summarization process.

According to some embodiments of the present disclosure, in a system, such as system 100A the score for each metric in the plurality of metrics 140a in FIG. 1A, may be calculated to measure the summary-text as a summary of the original text and then a rank-based normalization 150a in FIG. 1A may be applied to these metric-scores.

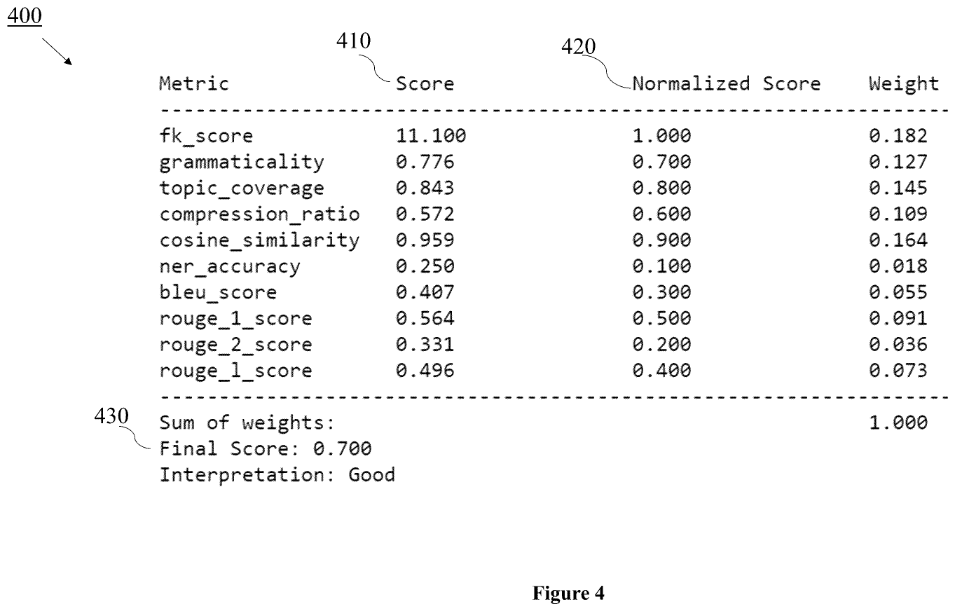

According to some embodiments of the present disclosure, weights may be assigned based on the normalized scores, e.g., 420 in FIG. 4, such that metrics that their metric-scores rank higher in their normalized score will have a higher weight.

According to some embodiments of the present disclosure, optionally, by setting a total weight to equal ‘1’ 220 and then after the calculation of the adjusted-weight for each metric-score, ensuring that the weights sum up to ‘1’, e.g., by step 240 to maintain consistency in the weighted scheme.

According to some embodiments of the present disclosure, in step 230, the weights of each metric-score may be adjusted based on their normalized scores, but these adjusted weights may not necessarily sum up to ‘1’.

According to some embodiments of the present disclosure, the ranked-based normalization removes scale bias, as scores from different sources might be measured on different scales, leading to biased comparisons. The normalization eliminates this bias by placing all values on the same scale. The ranked-based normalization further preserves order information, as instead of directly transforming the metric-scores, e.g., scores 410 in FIG. 4, into numerical values, ranked-based normalization retains the order information, preventing the loss of rank relationships among the data points.

According to some embodiments of the present disclosure, the ranked-based normalization is robust to outliers as it is less sensitive to outliers than other normalization techniques, making it suitable for datasets with extreme values. It facilitates fair comparisons by placing all scores on a common scale, thus ensures fair and unbiased comparisons.

According to some embodiments of the present disclosure, the ranked-based normalization retains order information. The normalization process maintains the rank relationships, enabling us to understand the relative performance of each data point, e.g., metric score 410 in FIG. 4. It is simple and robust as it is relatively simple to implement and is robust to outliers, making it suitable for a wide range of applications.

According to some embodiments of the present disclosure, the weighted hierarchical ranking combines multiple scores of metrics by assigning higher importance via the adjusted weights, to scores ranked higher after the normalization. Thus, highlighting the significance of higher-performing elements in the dataset, e.g., plurality of metrics 140a in FIG. 1A, making the final aggregated result, e.g., interpreted final-quality score 170a in FIG. 1A, more representative of the best performers, which are the metrics in the plurality of metrics 140a in FIG. 1A, that scored the summary-text with a higher score.

According to some embodiments of the present disclosure, the weighted hierarchical ranking is used for the aggregation because it enhances discrimination. By assigning higher weights to the top-ranked scores, the most exceptional data points, e.g., metric-scores are emphasized, thus, effectively increasing the discrimination power of the aggregation process. The discrimination power of the aggregation process in the weighted hierarchical ranking system refers to its enhanced ability to distinguish and emphasize the most significant or outstanding metric-scores by assigning them higher weights, thereby effectively identifying, and prioritizing the most critical aspects of text quality.

According to some embodiments of the present disclosure, another reason that the weighted hierarchical ranking is used for the aggregation is that it prioritizes high performers, e.g., high metric-scores. Weighted hierarchical ranking ensures that top performers substantially impact the final aggregated value, promoting the recognition of excellence in the dataset, e.g., metric-scores. The weighted hierarchical ranking further improves robustness as the hierarchical approach minimizes the influence of outliers or low-performing data points, making the aggregated result, e.g., interpreted final-quality score 170a in FIG. 1A more robust and resistant to extreme values.

According to some embodiments of the present disclosure, the weighted hierarchical ranking may be applied by performing ranked-based normalization on the raw scores, e.g., scores 410 in FIG. 4, bringing all values within a common scale, e.g., ‘0’ to ‘1’. Then, higher weights are assigned to higher normalized scores. This step amplifies the contribution of superior performances in the aggregation process to the value of interpreted final-quality score 170a in FIG. 1A.

According to some embodiments of the present disclosure, for example, the dataset [20,30,10,50], after the sorting step, the sorted dataset may be [50,30,20,10]. After the rank assignment step it may be: 10→1, 20→2, 30→3, 50→4. By dividing each rank by the total number of data points: 10→¼=0.25, 20>→ 2/4=0.5, 30→¾=0.75, 50→4/4=1, such that the final dataset may be [1,0.75,0.5,0.25].

According to some embodiments of the present disclosure, the weighted sum of the normalized scores may be calculated 250 to obtain the aggregated result, e.g., interpreted final-quality score 170a in FIG. 1A.

According to some embodiments of the present disclosure, the weighted hierarchical ranking may provide a fair representation as the aggregation accurately reflects the best contributions by prioritizing high-performing elements, customizable weighting, as the approach allows for flexibility in adjusting the weights based on the specific needs of the application or domain and support decision-making. When making decisions based on the aggregated scores, weighted hierarchical ranking ensures a more informed and justifiable outcome, which is the interpreted final-quality score 170a in FIG. 1A.

According to some embodiments of the present disclosure, by combining ranked-based normalization with aggregation based on weighted hierarchical ranking, the performance of the data points, e.g., metric-scores of the metrics, in the dataset, i.e., the scores of the plurality of metrics may be effectively analyzed and compared providing valuable insights and aiding decision-making processes.

According to some embodiments of the present disclosure, by providing a nuanced view of the performance across the plurality of metrics 140a in FIG. 1A, the combination of rank-based normalization and weighted hierarchical ranking allows for a multi-faceted approach to decision-making, extending far beyond just modifying text-prompts.

According to some embodiments of the present disclosure, the combination of rank-based normalization and weighted hierarchical ranking in analyzing metric-scores can facilitate various other decision-making processes, as follows. (i) model fine-tuning by identifying specific strengths and weaknesses in the metric-scores, the interpreted final-quality score 170a in system 100A in FIG. 1A can guide developers in fine-tuning the underlying algorithms of the text generation model, such as adjusting its parameters for better coherence, relevance, or linguistic correctness. (ii) training data optimization, insights from the aggregated scores can help in optimizing the training data used for the model. For example, if certain types of texts consistently yield lower scores, more representative samples of these texts can be included in the training set. (iii) feature development, the analysis might reveal the need for new features in the model, such as enhanced semantic analysis capabilities or improved handling of certain linguistic structures. (iv) user interface adjustments, if certain metrics consistently score lower, it could indicate a need to adjust the user interface or the way users interact with the system, making it easier for them to provide more effective inputs or feedback. (v) content strategy formulation, for content creators, the insights could inform broader content strategy decisions, like focusing on topics or styles that the system handles particularly well or avoiding those where it performs poorly. (vi) resource allocation, the decision-making process could extend to resource allocation, prioritizing development efforts and investments in areas where the most significant improvements in text quality can be achieved. (vii) quality control processes, the insights can be used to refine quality control processes, establishing benchmarks or standards for acceptable summary quality, and implementing checks or balances based on these metrics. (viii) educational and training purposes: In educational settings, these insights can inform teaching and training methods, helping students or users understand how to create more effective summaries or use the tool more efficiently.

FIGS. 3A-3B are a schematic flowchart of a computerized-method 300 for comprehensive text summarization quality assessment with rank-based normalization and weighted hierarchical ranking strategy, in accordance with some embodiments of the present disclosure.

According to some embodiments of the present disclosure, operation 310 comprising receiving an original text and a summary-text. The summary-text is a summary of the original text that has been generated by a Generative Pre-trained Transformer (GPT)-based Large Language Model (LLM) that has been provided the original text and a text-prompt.

According to some embodiments of the present disclosure, operation 320 comprising operating a text-processing Natural Language Processing (NLP) module on the received original text and the summary-text to yield a processed-text of the original text and a processed-text of the summary-text.

According to some embodiments of the present disclosure, operation 330 comprising measuring the summary-text to assess text summarization quality thereof by operating a plurality of metrics to yield a metric-score for each metric in the plurality of metrics. the measuring is based on the processed-text of the original text and the processed-text of the summary-text. The plurality of metrics, such as the plurality of metrics 140ain FIG. 1A, may be simultaneously operated.

According to some embodiments of the present disclosure, operation 340 comprising operating ranked-based normalization on each metric-score in the plurality of metrics to yield a normalized-score for each metric in the one or more metrics.

According to some embodiments of the present disclosure, operation 350 comprising operating an aggregation based on weighted hierarchical ranking strategy of the normalized scores to yield an interpreted final-quality score. The final-quality score indicates a comprehensive text summarization quality assessment of the summary-text. The plurality of metrics includes: (i) grammatically; (ii) Flesch-Kincaid (FK) readability; (iii) topic coverage; (iv) compression ratio; (v) cosine similarity; (vi) Named Entity Recognition (NER) accuracy; (vii) Bilingual Evaluation Understudy (BLEU); and (viii) Recall-Oriented Understudy for Gisting Evaluation (ROUGE).

FIG. 4 is a table 400 showing metrics and a score, a normalized score and assigned weight for each metric, in accordance with some embodiments of the present disclosure.

According to some embodiments of the present disclosure, the score 410 of each metric is a metric-score for a summary-text, such as summary-text 110a in FIG. 1A and such as summary-text 520 in FIG. 5 and such as summary-text 110b in FIG. 1B, that has been generated by a Generative Pre-trained Transformer (GPT)-based Large Language Model (LLM) that has been provided the original text and a text-prompt. The metric-score has been yielded by operating the metric on a processed-text of the original text and the processed-text of the summary-text. The processed-text of the original text and the processed-text of the summary-text have been yielded by operating a text-processing Natural Language Processing (NLP) module, such as text-processing NLP module 130a in FIG. 1A, on the original text and the summary-text, such as original text 120a in FIG. 1A and summary-text 110 in FIG. 1A.

According to some embodiments of the present disclosure, the normalized score of each metric-score has been calculated by sorting the plurality of metrics by the measured metric-score of each metric in the plurality of metrics to yield a sorted list of metrics. For example, the scores in table 400 have been sorted as follows: [11.100 A, 0.959, 0.843, 0.776, 0.572, 0.564, 0.496, 0.407, 0.331, 0.250]. Then, a rank may be assigned to each metric based on a position of the metric in the sorted list of metrics. For example, [11.100 A→1, 0.959→2, 0.843→3, 0.776→4, 0.572→5, 0.564→6, 0.496→7, 0.407→8, 0.331→9, 0.250→10]. The total number of metrics in the list of metrics in table 400 is 10 and each rank may be divided by the total number to yield the ranked-normalized score. [10/10, 9/10, 8/10, 7/10, 6/10, 5/10, 4/10, 3/10, 2/10, 1/10].

According to some embodiments of the present disclosure, the adjusted-weight of each normalized-score 420 may be calculated by having the normalized-score multiplied by a multiplicative inverse of the sum of the normalized-score of each metric in the plurality of metrics.

FIG. 5 is an example 500 of an original text and generated summary-text, in accordance with some embodiments of the present disclosure.

According to some embodiments of the present disclosure, summary-text 520 is a summary of the original text 510 that has been generated by a Generative Pre-trained Transformer (GPT)-based Large Language Model (LLM) that has been provided the original text 510 and a text-prompt.

According to some embodiments of the present disclosure, the summary-text may be provided a score for its quality by a system, such as system 100A in FIG. 1A or by computerized-method 300 in FIG. 3, for a comprehensive text summarization quality assessment with rank-based normalization and weighted hierarchical ranking strategy, which may yield a score, such as interpreted final-quality score 170a in FIG. 1A, and such as final score 430 in FIG. 4.

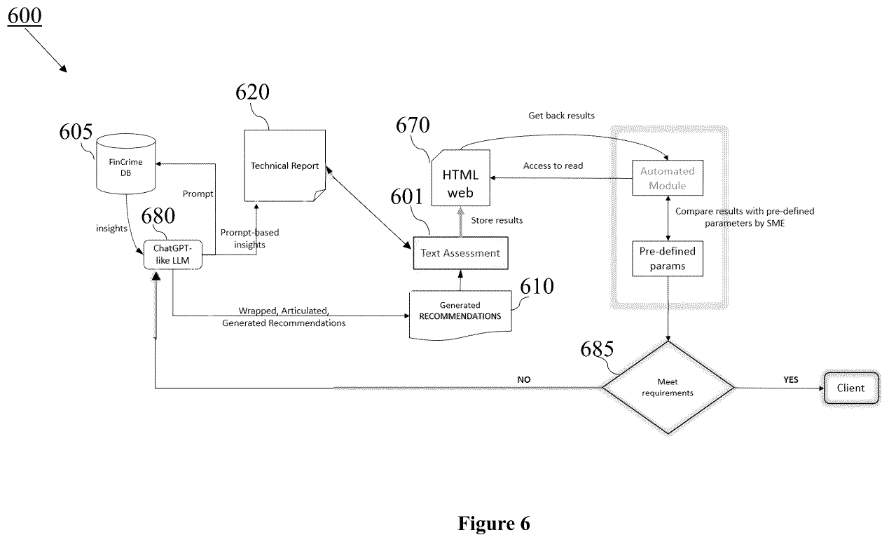

FIG. 6 schematically illustrates a high-level diagram of a system 600 for quality evaluation with reference and distribution workflow, in accordance with some embodiments of the present disclosure.

According to some embodiments of the present disclosure, to provide a client a technical report 620 and related GPT-based LLM generated recommendations 610, a system, such as system 100A in FIG. 1A for comprehensive text summarization quality assessment with rank-based normalization and weighted hierarchical ranking strategy and such as system 100B in FIG. 1B for comprehensive text summarization quality assessment with rank-based normalization and weighted hierarchical ranking strategy, may be implemented for text assessment 601 of the GPT-based LLM generated recommendations 610, in a system for quality evaluation with reference and distribution workflow 600.

According to some embodiments of the present disclosure, to train the chatGPT-like LLM 680 to provide recommendations based on a technical report of financial crime transactions, a text-prompt may be provided to a chat-GPT-like LLM 680, such as GPT-based LLM 180a in FIG. 1A and such as GPT-based LLM 180b in FIG. 1B, which may be applied on transactions in a financial crime database, such as FinCrime DB 605, by a query to provide insights as to the transactions in the FinCrime DB 605 to the chatGPT-like LLM 680. The query may be for example, “how many transactions has an amount above $500?”. The insight may be for example, “all transactions that happened after 12 PM”.

According to some embodiments of the present disclosure, the chatGPT-like LLM 680 may be provided a prompt-based insights to generate a technical report of financial crime transactions, such as technical report 620.

According to some embodiments of the present disclosure, the chatGPT-like LLM 680 may be provided a text-prompt and the technical report 620, to generate recommendations, e.g., generated recommendations 610, in the same manner as the original-text 120a in FIG. 1A and the text-prompt have been provided to the GPT-based LLM 180a in FIG. 1A to generate the summary-text 110a in FIG. 1A. The recommendations may be for example, “check all transactions after 12 PM”, check if the trend exists hourly” “If yes, then activate procedure 1701 and mode special-operation”.

According to some embodiments of the present disclosure, the chat-GPT-like LLM 680 may generate recommendations, e.g., generated recommendations 610, which may be evaluated for comprehensive text summarization quality assessment with rank-based normalization and weighted hierarchical ranking strategy by the text assessment 601.

According to some embodiments of the present disclosure, the text assessment 601 may provide results which may include an interpreted final quality score of the generated recommendations 610, such as interpreted final-quality score 170a in FIG. 1A which may indicate a comprehensive text summarization quality assessment of the generated recommendations 610, as well as the score of each metric in the plurality of metrics, such as plurality of metrics 140a in FIG. 1A, as shown in FIG. 4.

According to some embodiments of the present disclosure, the results e.g., interpreted final-quality score of the text assessment 601, such as system 100 in FIG. 1 and system 100B in FIG. 1B, and the score of each metric, as shown in FIG. 4, may be stored in an Hyper Text Markup Language (HTML) web 670 to be accessed via an automated module to automatically compare based on one or more predefined parameters the results.

According to some embodiments of the present disclosure, checking if the results meet the requirements 685, and when the comparison by the automated module indicates that the requirements are met the generated recommendations 610 and the technical report 620 may be forwarded to the client as well as the insights, diagnostic analysis, and summaries.

According to some embodiments of the present disclosure, when the comparison by the automated module indicates that the requirements were not met, the generated recommendations 610 and the technical report 620 may be forwarded as feedback-details to the chatGPT-like LLM 680 for further tuning and refinement of the chatGPT-like LLM 680 to improve the quality results of the comprehensive text summarization quality assessment with rank-based normalization and weighted hierarchical ranking strategy of the text assessment 601. The tuning and refinement of the chatGPT-like LLM 680 may be by modifying the text-prompt or adjusting certain parameters of the chatGPT-like LLM 680, such as GPT-based LLM 180b in FIG. 1b, as described in system 100B in FIG. 1B.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for comprehensive text summarization quality assessment with rank-based normalization and weighted hierarchical ranking strategy, said computerized-method comprising:
(i) receiving an original text and a summary-text,
wherein said summary-text is a summary of the original text that has been generated by a Generative Pre-trained Transformer (GPT)-based Large Language Model (LLM) that has been provided the original text and a text-prompt;
(ii) operating a text-processing Natural Language Processing (NLP) module on the received original text and the summary-text to yield a processed-text of the original text and a processed-text of the summary-text;
(iii) measuring the summary-text to assess text summarization quality thereof by operating a plurality of metrics to yield a metric-score for each metric in the plurality of metrics,
wherein the measuring is based on the processed-text of the original text and the processed-text of the summary-text;
(iv) operating ranked-based normalization on each metric-score in the plurality of metrics to yield a normalized-score for each metric in the plurality of metrics; and
(v) operating an aggregation based on weighted hierarchical ranking strategy of the normalized scores to yield an interpreted final-quality score,
wherein the interpreted final-quality score indicates a comprehensive text summarization quality assessment of the summary-text, and
wherein the plurality of metrics includes: (a) grammatically; (b) Flesch-Kincaid (FK) readability; (c) topic coverage; (d) compression ratio; (e) cosine similarity; (f) Named Entity Recognition (NER) accuracy; (g) Bilingual Evaluation Understudy (BLEU); and (h) Recall-Oriented Understudy for Gisting Evaluation (ROUGE).

2. The computerized-method of claim 1, wherein said text-processing NLP module comprising: (i) operating tokenization of the received original text and the summary-text to yield a plurality of tokens; (ii) operating lemmatization of each token in the plurality of tokens; and (iii) operating Named Entity Recognition (NER) to extract entities by classifying each token in the plurality of tokens into a category in predefined categories.

3. The computerized-method of claim 1, wherein the ranked-based normalization comprising:
(i) sorting the plurality of metrics by the measured metric-score of each metric in the plurality of metrics to yield a sorted list of metrics;
(ii) assigning a rank to each metric based on a position of the metric in the sorted list of metrics; and
(iii) dividing each rank by a total number of metrics in the list of metrics.

4. The computerized-method of claim 1, wherein when the interpreted final-quality score is below a preconfigured threshold, said computerized-method further comprising providing feedback-details to a user via a computerized-device to modify the text-prompt and receive a regenerated summary-text of the original text from the GPT-based LLM, based on the feedback-details and then performing operations (ii) through (v).

5. The computerized-method of claim 4, wherein the feedback-details include the metric-score of each metric in the plurality of metrics.

6. The computerized-method of claim 4, wherein the feedback-details include a preconfigured number of metrics having lowest metric-score.

7. The computerized-method of claim 4, wherein the feedback-details include integrated resources, and wherein the integrated resources include at least one of: (i) style guides; (ii) grammatical rules; and (iii) topic-specific templates.

8. The computerized-method of claim 4, wherein when lowest metric scores are of at least one metrics of: grammatically and topic coverage the feedback-details provides references to relevant resources from website and academic papers, and professional literature.

9. The computerized-method of claim 4, wherein when the interpreted final-quality score is below the preconfigured threshold and there is an indication that a feedback-loop is not required, feedback-details are not provided to the GPT-based LLM to receive the regenerated summary-text.

10. The computerized-method of claim 4, wherein when the interpreted final-quality score of a summary-text is below the preconfigured threshold, said computerized-method further comprising storing the interpreted final-quality score in a database with related original text, summary-text and the plurality of metrics and corresponding metric-scores.

11. The computerized-method of claim 10, wherein when the interpreted final-quality score of a summary-text is below the preconfigured threshold, said computerized-method further comprising retrieving from the database previously stored one or more interpreted final-quality score, and related summary-text and the plurality of metrics and corresponding metric-scores to be presented via a display unit to a user.

12. The computerized-method of claim 4, wherein said computerized-method further comprising storing in a documentation-database details of the interpreted final-quality score of a summary-text that is below the preconfigured threshold, related summary-text, feedback-details and user modifications to the GPT-based LLM to regenerate the summary-text.

13. The computerized-method of claim 1, wherein the aggregation based on weighted hierarchical ranking strategy of the normalized scores comprising:
(i) calculating a sum of the normalized-score of each metric in the plurality of metrics;
(ii) for each normalized-score of the plurality of metrics assigning an adjusted-weight; and
(iii) calculating the interpreted final-quality score by summing weighted normalized scores,
wherein a weight of each normalized-score is the assigned adjusted-weight.

14. The computerized-method of claim 13, wherein the adjusted-weight of each normalized-score is calculated by having the normalized-score multiplied by a multiplicative inverse of the normalized-score of each metric in the plurality of metrics.

15. The computerized-method of claim 13, wherein when the text-processing NLP module identifies a context of the summary-text, the adjusted-weight of each normalized-score is determined by the identified context of the summary.
